(19) United States
(12) Patent Application Publication
(10) Pub. No.: US 2002/0172570 A1
(43) Pub. Date: Nov. 21, 2002

(54) Ultra high speed movement telescopic covers

(75) Inventor: Yoshihisa Tsurumaki, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TOKYO SEIMITSU HATSUJO., LTD, Tokyo (JP)

(21) Appl. No.: 09/859,471

(22) Filed: May 18, 2001

(51) Int. Cl. B23Q 11/08

(52) U.S. Cl. 409/134; 409/235

(57) ABSTRACT

The ultra high speed movement telescopic cover which comprises multiple pieces of partial covers using metallic film of high tensile strength multiple layer texture stainless steel which comprises 17% Cr˜2% Ni content but with mixed quality of mild ferritic phase, hard maltensitic phase and fine mixed texture and are stacked so as to be able to slide each other, fitted with metallic film blade made of 0.01˜0.3 mm thickness and of carbon content 0.03˜0.1%, Chromium content 10˜20% steel or stainless steel onto one or whole sliding portions of the said telescopic cover, fitted with one or multiple pieces of pantograph onto each partial cover and the end of said telescopic cover thus constructed is fixed to the moving device of main spindle head etc. of the high speed operation industrial machinery, to have said telescopic cover back or forth and left or right, with the movement of moving device of high speed operation industrial machinery, to seal to discharge chips and/or coolant by the sliding movement of the multiple blade pieces, and to improve characteristics of sliding ability etc.

### BACKGROUND OF THE INVENTION

1. Field of the Invention

The present invention relates to an ultra high speed movement telescopic cover.

2. Discussion of the Background

So far, when metallic material is cut, for instance, by a cutting machine, the generated chips and spatters (hereafter called chips) penetrate into adjacent moving parts such as spindle heads etc. and caused obstacles against smooth slide movement and/or wears of moving device(s) of the high speed operation industrial machinery, consequently the fall of performance of the high speed operation industrial machinery.

Especially upon cutting work of metallic material by a ultra high speed machine tool, for the purpose to remove chips and/or to cool heated material, abundant coolant is sprayed onto the work on the machine tool, so that once such coolant used in quantity, it penetrates into the adjacent moving parts such as the spindle head of high speed operation industrial machinery, it cause to rust and to worsen the sliding ability of the moving device of high speed operation industrial machinery, resulting in the fall of performance of the high speed operation industrial machinery.

As a countermeasure to these problems, the high speed operation industrial machinery which has bare moving device such as spindle head etc., is used to be protected by cover(s) over the machinery and/or it's part, which covers are usually bellows made of cloth or vinyl material but these materials are problematic in physical strength. Instead of these materials, telescopic type covers which slides in the one way direction reciprocally and consists of stacked thin metallic partial covers sliding over the other covers in order of the stacking, are being in use with some specific high speed operation industrial machinery today.

For instance, the conventional telescopic cover, as shown in FIG. 1, has more than one partial covers 2a˜e of quadrilateral shape made of metallic sheet stacked over the other partial cover and is so constructed that each partial cover plate 2a˜e slides on the right and the left directions which are fitted with thin blade 3 made of rubber material in one body at the end of each partial cover 2a˜e where the plate end contacts with the other plates 2a˜e. The materials of blade 3 are of felt, vinyl etc. as well as rubber.

Furthermore, these telescopic cover 1, as shown in FIG. 2, covers an high speed operation industrial machinery 5 with one end of the partial cover 2a fixed onto moving device 4 of the high speed operation industrial machinery 5 also with the other end of the partial cover 2e fixed onto the fixing device 6 of the high speed operation industrial machinery 5 and each partial covers 2a˜e slide in the right and left directions reciprocally along with the right and left movement of moving device 4 of the high speed operation industrial machinery 5.

Namely along with the left ward movement of the moving device of the high speed operation industrial machinery 5, partial covers 2a˜e of the telescopic cover 1 are extended towards left, and the rubber made blade 3 slides towards the left so that chips and/or coolant are discharged out, then, along with the right ward movement of the moving device of the high speed operation industrial machinery 5, partial covers 2a˜e of the telescopic cover 1 are shrank and the rubber make blade 3 slides towards the right so that chips and/or coolant are discharged out, thus the penetration of those chips and/or coolant towards inside of the moving device 4 of the high speed operation industrial machinery 5 through gaps of the partial cover plate 2a˜e are prevented.

Also, above mentioned telescopic cover (partial covers) are used to be made of steel sheet (SS41 and/or PSC etc.) and they are problematic in the points of heavy load onto telescopic covers, which heavy load causes increased frictional resistance resulting in the various problems on sliding characteristics, endurance, frictional wear, abrasion resistance, physical strength, desired light weight etc.

Also, the above mentioned telescopic cover is used to be made of stainless steel sheet (SUS301H, SUS304H, SUS63, SUS631 etc.) but these materials are problematic in the wide use due to the points of higher cost, corrosive resistance, heat treatments of hardening and annealing etc.

Also, for the above mentioned telescopic cover 1, partial coves 2a˜e are independent and partial each other and not connected with each other, therefore, the partial cover 2b is, for instance, so mechanized mostly as to be moved by partial cover 2a. In this case, each partial covers 2a˜e do not slide simultaneously and with the same travelling distances but each partial covers 2a˜e moves unequally from the cover of easy to move first leaving some other covers unmoved. Consequently the whole telescopic cover 1 does not slide smoothly and is inconvenient to use due to lacking of linear movement, generation of abnormal noise, frequent failure etc.

Also, rubber blade 3 attached to the conventional telescopic cover 1 is so thick (3˜10 mm) that the gaps between each cover plate 3 tend to become wider (10˜20 mm). Consequently, there were inevitable weak points that chips and/or coolant penetrate inside, the shape of each cover plate 2a˜e becomes larger and heavier, the telescopic cover 1 becomes larger and heavier and the blade 3 becomes so easily worn to call forth inferior sliding movement and lower endurance etc.

Also, the rubber made blade 3 provided to the above mentioned conventional telescopic cover 1 is a piece of flat bar plate and the whole bottom face of the blade 3 is expected to slide in contact with the whole face of the partial covers 2a˜e. However, it is difficult to have the whole bottom face of the blade 3 contact through the whole surface of the partial covers 2a˜e, due to the condition of wear and/or deteriorated blade 3 and of uneven surfaces of the each partial covers 2a˜e.

Namely the bottom face of the blade 3 tend to have partial contact with the surface of each partial covers 2˜e forming point contacts so that these point contacts cause problem of gaps in the contact surface with the blade 3, through which gaps chips and coolant penetrate inside causing an weak point to reduce sealing and sweeping characteristic. Especially in case that each partial covers 2a˜e are made in shape of round or oval forms and the blade 3 is fitted at the curved edge, it causes point contact easily causing reductions of sealing and sweeping characteristics.

Also, the way of fitting of the blade 3 to each partial covers 2a˜e of the above mentioned conventional telescopic cover 1 is made usually at the edge of each partial cover 2a˜e only. Therefore, there exist wide gaps at the spots of left and right edges and rear edges of each partial covers 2a˜e where no blade 3 is fitted and penetration of chips and coolant from those gaps were unavoidable.

Also, among the recent high speed operation industrial machinery, moving device of covers provided for main spindle, spindle head, bed, table, column, piston, cylinder, ATC cover etc. is made so that it travels not only one way of back and forth, right and left, up and down but also travels two cross ways such as back and forth as well as left and right, left and right as well as up and down etc. then the conventional cover materials used for one way movement are problematic in use of these cross way movement.

Especially, with the telescopic cover which moves in the cross ways directions, it is hard to fit blade to the whole four square of the sliding part and the penetration of chips and coolant is problematic.

### SUMMARY OF THE INVENTION

This invention is purposed to the following:

To cover whole high speed operation industrial machinery; to let the ultra high speed movement telescopic cover (move by 60˜120 meter per one minute) fitted with metallic film blades to slide adequately back to forth, left to right, up to down, etc. almost in the same plane level along with the reciprocal movement of the spindle head etc. of the high speed operation industrial machinery of back to forth, left to right, up to down, etc.; to discharge chips and coolant; to prevent chips and/coolant penetrating into moving device of high speed operation industrial machinery though the gaps of ultra high speed movement telescopic cover; to maintain movements of moving device of high speed operation industrial machinery so that high speed operation industrial machinery is able to contribute its full performance.

Also, this invention is purposed the following:

To reduce the thickness of each cover so that ultra high speed movement telescopic cover (move by 60˜120 meter per one minute) becomes compact in size and lighter in weight by using high strength multiple layer texture stainless steel as the material of partial covers of the above mentioned ultra high speed movement telescopic cover and to improve elasticity, sliding ability, frictional resistance, endurance and physical strength of the ultra high speed movement telescopic cover.

Also, this invention is purposed the following:

To use the steel or stainless steel of carbon content 0.03˜0.1% and chromium content 10˜20% with the thickness of 0.1˜0.3 mm as the material for the metallic film blade to be fixed to each partial cover of the above mentioned ultra high speed movement telescopic cover (move by 60˜120 meter per one minute), to improve hardness, elasticity, physical strength of the blade, to reduce frictional resistance of the blade by the reductions of blade size, thickness and contact area and to improve remarkably the endurance ability, sliding ability, sealing ability and sweeping ability.

To use the blades divided in multiple piece as the blade to be fixed to the sliding part of the end of the above mentioned ultra high speed movement telescopic cover sliding reciprocally so that the contact points of blades and the cover surfaces become multiple point contacts making the contact condition closer to the plane surface contact, resulting in the remarkable improvements of discharge of chips and/or coolant and sealing ability.

Also, this invention is purposed the following:

To provide pantograph mechanism to the above mentioned ultra high speed movement telescopic cover (move by 60˜120 meter per one minute), to provide each partial cover with the simultaneous and even distances slide movements, to provide ultra high speed movement telescopic cover with linear movement for smoother movement and furthermore to give full performance of machinery by maintaining smooth movement of the moving device of high speed operation industrial machinery.

And also this invention is purposed to improve characteristics of simultaneous movement and linear movement of the ultra high speed movement telescopic cover and each partial covers and to let the ultra high speed movement telescopic cover slide lightly, stably and with lower noise by the braking and shock absorbing features.

Also, this invention is purposed the following:

To use high strength multiple layer texture stainless steel for the material of the pantograph mechanism to be fitted to each partial covers of the above mentioned ultra high speed movement telescopic cover (move by 60˜120 meter per one minute) to improve elasticity, sliding ability, frictional resistance, endurance ability and physical strength of the ultra high speed movement telescopic cover by the reductions of thickness of each partial covers, sizes of covers in compact and of the weight.

Also, this invention is purposed the following:

To use shock-absorbing material in ring shape to the fitting spindle of the pantograph mechanism to be fitted to each partial cover of the above mentioned ultra high speed movement telescopic cover (move by 60˜120 meter per one minute) so that the shock is absorbed upon the pantograph is shrunken.

Also, this invention is purposed the following:

To use the smoothing device such as of roller(s) and rails(s) and/or slide guide(s) and rail(s) with the pantograph mechanism to be fitted to each partial covers of the above mentioned ultra high speed movement telescopic covers (move by 60˜120 meter per one minute) so that smooth operation of sliding movement is achieved as well as shocks are absorbed upon th4 pantographs are shrunken.

Also This invention is purposed to the following:

To cover whole high speed operation industrial machinery; to let the ultra high speed movement telescopic cover (move by 60˜120 meter per one minute) fitted with metallic film blades to slide in the cross ways directions adequately back and forth, forth and back, left to right, right to left, up and down, down and up etc. almost in the same plane level along with the reciprocal movement of the spindle head etc. of the high speed operation industrial machinery in the cross way directions of back and forth, left and right, right and left, up and down etc.; to discharge chips and coolant; to prevent chips and/coolant penetrating into moving device of high speed operation industrial machinery though the gaps of ultra high speed movement telescopic cover; to maintain movements of moving device of high speed operation industrial machinery so that high speed operation industrial machinery is able to contribute its full performance.

Also, this invention is purposed the following:

To reduce the thickness of each cover so that ultra high speed movement telescopic cover (move by 60˜120 meter per one minute) which slides reciprocally in the cross ways directions, becomes compact in size and lighter in weight by using high strength multiple layer texture stainless steel as the material of partial covers of the above mentioned ultra high speed movement telescopic cover which slides reciprocally in the cross ways directions and to improve elasticity, sliding ability, frictional resistance, endurance and physical strength of the ultra high speed movement telescopic cover.

Also, this invention is purposed the following:

To use the above mentioned steel or stainless steel of carbon content 0.03˜0.1% and chromium content 10˜20% with the thickness of 0.1˜0.3 mm as the material for the metallic film blade to be fixed to each partial cover of the above mentioned ultra high speed movement telescopic cover (move by 60˜120 meter per one minute) which slide in the cross ways directions reciprocally, to improve hardness, elasticity, physical strength of the blade, to reduce frictional resistance of the blade by the reductions of blade size, thickness and contact area and to improve remarkably the endurance ability, sliding ability, sealing ability and sweeping ability.

To use the blades divided in the above mentioned multiple piece as the blade to be fixed to the sliding part of the end of the above mentioned ultra high speed movement telescopic cover sliding in the cross ways directions reciprocally so that the contact points of blades and the cover surfaces become multiple point contacts making the contact condition closer to the plane surface contact, resulting in the remarkable improvements of discharge of chips and/or coolant and sealing ability.

Also, this invention is purposed the following:

To provide pantograph mechanism to the above mentioned ultra high speed movement telescopic cover (move by 60˜120 meter per one minute) which slide in the cross ways directions reciprocally, to provide each partial cover with the simultaneous and even distances slide movements, to provide ultra high speed movement telescopic cover with linear movement for smoother movement and furthermore and to give full performance of machinery by maintaining smooth movement of the moving device of high speed operation industrial machinery.

Furthermore to improve characteristics of simultaneous movement and linear movement of the ultra high speed movement telescopic cover and each partial covers which slide in the crossways directions reciprocally and to let the ultra high speed movement telescopic cover slide lightly, stably and with lower noise.

Also, this invention is purposed the following:

To use above mentioned high strength multiple layer texture stainless steel for the material of the pantograph mechanism to be fitted to each partial covers of the above mentioned ultra high speed movement telescopic cover (move by 60˜120 meter per one minute) which slides in the cross ways directions reciprocally and to improve elasticity, sliding ability, frictional resistance, endurance ability and physical strength of the ultra high speed movement telescopic cover by the reductions of thickness of each partial covers, sizes of covers in compact and of the weight.

Also, this invention is purposed the following:

To use shock absorbing material in ring shape to the pantograph mechanism to be fitted to each partial covers of the above mentioned ultra high speed movement telescopic cover (move by 60˜120 meter per one minute) which slides in the cross ways directions reciprocally so that the shocks are absorbed upon the pantographs are shrunken.

Also, this invention is purposed the following:

To use smoothing device such as roller(s) and rail(s) and/or slide guide(s) and slide rail(s) with the pantograph mechanism to be fitted to each partial covers of the above mentioned ultra high speed movement telescopic cover (move by 60˜120 meter per one minute) which slides in the cross ways directions reciprocally so that smooth operation of sliding movement is achieved as well as the shocks are absorbed upon the pantographs are shrunken.

This invention is related to the ultra high speed movement telescopic cover (move by 60˜120 meter per one minute) and the features of this invention are in the ultra high speed movement telescopic cover(s), which consist of multiple pieces of partial covers using metallic film of high tensile strength multiple layer texture stainless steel which consists mainly of 17% Cr˜2% Ni content but with mixed quality of mild ferritic phase, hard maltensitic phase and fine mixed texture and are stacked so as to be able to slide each other, fitted with metallic film blade made of 0.01˜0.3 mm thickness and of carbon content 0.03˜0.1%, Chromium content 10˜20% steel or stainless steel onto one or whole sliding portions of the ultra high speed movement telescopic cover, fitted with one or multiple pieces of pantograph onto each partial cover and the end of ultra high speed movement telescopic cover thus constructed is fixed to the moving device of main spindle head etc. of the high speed operation industrial machinery, to have ultra high speed movement telescopic cover back or forth and left or right, with the movement of moving device of high speed operation industrial machinery, to seal to discharge chips and/or coolant by the sliding movement of the multiple blade pieces, and to improve characteristics of sliding ability etc.

Also this invention is related to the above mentioned ultra high speed movement telescopic cover (move by 60˜120 meter per one minute) and it is the feature of this invention to provide with metallic film blade which made of 0.01˜0.3 mm thickness and of carbon content 0.03˜0.1%, Chromium content 10˜20% steel or stainless steel with the spacing of 1˜5 mm onto one or whole sliding portions of the ultra high speed movement telescopic cover, and fitted with one or multiple pieces of pantograph onto the ultra high speed movement telescopic cover.

Also, this invention has the following features:

To form the pantograph using the metallic film of 17% Cr˜2% Ni high strength stainless steel of which consists of multiple layer fine mixed texture of mild ferritic phase and maltensitic phase, which pantograph is fitted onto the to improve remarkably the characteristics in sliding ability, elasticity, friction resistance, endurance ability, physical strength etc. of the ultra high speed movement telescopic cover (move by 60˜120 meter per one minute)

Also, this invention has a feature that the above mentioned pantographs fitted onto the ultra high speed movement telescopic cover (move by 60˜120 meter per one minute), are inserted to the sliding pin(s) and fitting pin(s) with shock absorbing material in ring shape of the slightly larger outer diameter than the connecting bar of the pantograph or with slide control material in ring shape of the same outer diameter as the width of the connecting bar of the pantograph or to insert a slide control material in ring shape into the into the shock absorbing material in ring shape of the outer diameter slightly larger than the width of the connecting bar of the pantograph(s), so that the shocks caused by the collision of connecting bars are absorbed upon the shrinking of the pantograph(s).

Also this invention has a feature that the partial covers of the above mentioned ultra high speed movement telescopic covers (move by 60˜120 meter per one minute) are fitted with movement smoothing device such as roller(s) and rail(s) or slide control guide(s) and slide rail(s) at least at the four corners or more so that the sliding characteristics of the ultra high speed movement telescopic cover(s) are improved.

Also, this invention is relating to the ultra high speed movement telescopic covers (move by 60˜120 meter per one minute) which slide in the cross ways directions and consist of the center ultra high speed movement telescopic covers and the side ultra high speed movement telescopic covers and it is the feature to form each partial cover of the above mentioned central ultra high speed movement telescopic cover and side ultra high speed movement telescopic cover using metallic film of high tensile strength multiple layer texture stainless steel which consists mainly of 17% Cr˜2% Ni content but with mixed quality of mild ferritic phase, hard maltensitic phase and fine mixed texture and are stacked so as to be able to slide each other, and the both ultra high speed movement telescopic cover fitted with metallic film blade which made of 0.01˜0.3 mm thickness and of carbon content 0.03˜0.1%, Chromium content 10˜20% steel or stainless steel onto one or whole sliding portions of the both ultra high speed movement telescopic cover, and fitted with one or multiple pieces of pantograph onto the ultra high speed movement telescopic cover and the center ultra high speed movement telescopic covers which are stacked so as to be able to slide each other, at the both sides of the center ultra high speed movement telescopic cover where the mounting holes are provided for moving device of main spindle head etc. of the high speed operation industrial machinery, to provide, at the one side or both sides of the center ultra high speed movement telescopic cover, and the side ultra high speed movement telescopic covers which are stacked so as to be able to slide each other, also to provide the sliding direction of the partial covers of the side ultra high speed movement telescopic cover so as to be able to slide in the right angle direction almost in the same plane level and to have both of the center ultra high speed movement telescopic cover and the side ultra high speed movement telescopic cover slid in the cross ways directions either back to forth and left to right, and/or right to left almost in the same plane level along with the movement of moving device of high speed operation industrial machinery to seal to discharge chips and/or coolant by the sliding movement of the multiple blade pieces, and to improve characteristics of sliding ability etc.

Also, this invention is related to the above mentioned ultra high speed movement telescopic covers (move by 60˜120 meter per one minute) which slide in the cross ways directions and consist of the center ultra high speed movement telescopic covers and the side ultra high speed movement telescopic covers and it is the features of this invention to have the both ultra high speed movement telescopic covers fitted with metallic film blade which made of 0.01˜0.3 mm thickness and of carbon content 0.03˜0.1%, Chromium content 10˜20% steel or stainless steel with the spacing of 1˜5 mm onto one or whole sliding portions of the both ultra high speed movement telescopic cover.

Also this invention have the features to form the pantograph using the metallic film of 17% Cr˜2% Ni high strength stainless steel of which consists of multiple layer fine mixed texture of mild ferritic phase and maltensitic phase, which pantograph is fitted onto the central ultra high speed movement telescopic cover (move by 60˜120 meter per one minute) and the side ultra high speed movement telescopic cover which slide in the cross ways directions reciprocally and to improve remarkably the characteristics in sliding ability, elasticity, friction resistance, endurance ability, physical strength etc. of the ultra high speed movement telescopic cover which slide in the cross ways directions reciprocally

Also, this invention have the features that are to fit to the slide pin(s) and fitting pin(s) of the above mentioned center and side ultra high speed movement telescopic covers (move by 60˜120 meter per one minute) which slide in the cross ways direction with shock absorbing material in ring shape with the diameter of a slightly larger than the width of the connecting bar of the pantographs or slide control material in ring shape of the diameter of the almost same size with the width of the connecting bar of the pantographs or insert the slide control material into the shock absorbing material of the diameter of a slightly larger than the width of the connecting bar of the pantograph so that the shocks by the collision of pantographs are absorbed upon the pantographs are shrunken.

Also this invention has the feature that the slide function device is fitted to the above-mentioned ultra high speed movement telescopic cover (move by 60˜120 meter per one minute) and side ultra high speed movement telescopic cover (move by 60˜120 meter per one minute) which slide in the cross ways direction reciprocally, with the roller(s)and rail(s) or slide control guide(s) and guide rail(s) at least at the four corners or more so that the sliding characteristics are improved.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is the plan view of the conventional telescopic cover which is provided with stacks of sliding multiple pieces of metallic sheet partial covers fitted with rubber blades,

FIG. 2 is the side view of the conventional telescopic cover,

FIG. 3 is the development view of the ultra high speed movement telescopic cover of this invention, showing fitting condition of metallic film blades onto each partial covers of this invention which are constructed by the ultra high speed movement telescopic cover,

FIG. 4 is the development view showing fitting condition of multiple pieces of metallic film blades on to the one face of the each partial cover with spacing at the sliding part of ultra high speed movement telescopic cover of this invention,

FIG. 5 is the side view of the fitting condition of the pantograph onto the ultra high speed movement telescopic cover of this invention,

FIG. 6 is the plan view showing provision of the ultra high speed movement telescopic cover of this invention provided with two (2) sets of the ultra high speed movement telescopic cover consist of metallic film partial covers,

FIG. 7 is the fixing condition of the fitting pins of pantograph to the sliding cover of this invention as well as the setting condition of the sliding fitting pins of the pantograph into the slit guide of the slit plates fixed on the ultra high speed movement telescopic cover,

FIG. 8 is the plan view of the ultra high speed movement telescopic covers of this invention showing fitting condition of the pantograph onto the recess portion provided on the metallic film partial cover,

FIG. 9 is the side view showing the fitting condition of the pantograph onto the ultra high speed movement telescopic cover through the fitting of shock absorbing material in ring shape to the fitting pins and slide pins,

FIG. 10 is the section view showing fitting condition of the shock absorbing material in ring shape with outerdiameter of slightly larger than the width of convection bar of the pantograph of this invention into the slide pins and fitting pins,

FIG. 11 is the side view showing fitting condition of the slide control material in ring shape with outerdiameter of almost same size as the width of convection bar of the pantograph of this invention into the slide pins and fitting pins,

FIG. 12 is the side sectional view showing fitting condition of the slide control material in ring shape into the shock absorbing material with outerdiameter of a slightly larger than the width of convection bar of the pantograph of this invention through to the slide pins and fitting pins,.

FIG. 13 is the sectional view showing fitting condition of the rollers onto partial cover of the ultra high speed movement telescopic cover of this invention,

FIG. 14 is the sectional view showing fitting condition of the slide control guide onto partial cover of the ultra high speed movement telescopic cover of this invention,

FIG. 15 is the development view of the ultra high speed movement telescopic cover of this invention which slide in the cross ways directions and constructed by center ultra high speed movement telescopic cover and side ultra high speed movement telescopic cover, the

FIG. 16. is the development view showing fitting condition of metallic film blades onto each partial covers of this invention which slide in the cross ways directions and are constructed by the center ultra high speed movement telescopic cover and the side ultra high speed movement telescopic cover and

FIG. 17 is the plan view showing fitting condition of metallic film blades as well as pantograph onto the cross ways sliding ultra high speed movement telescopic cover of this invention

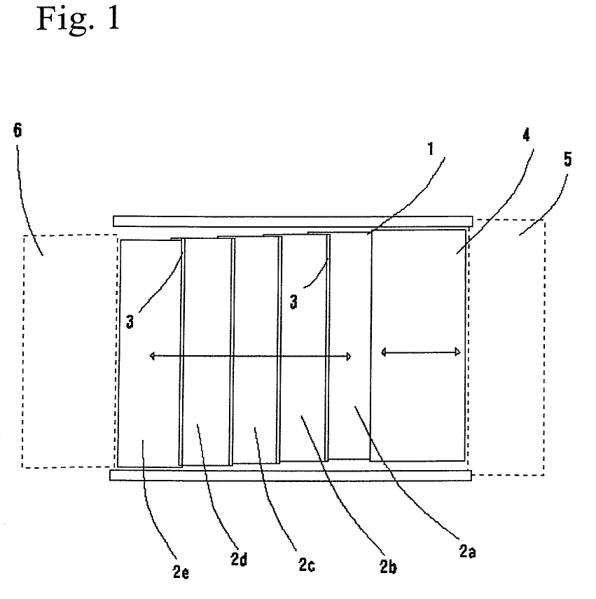

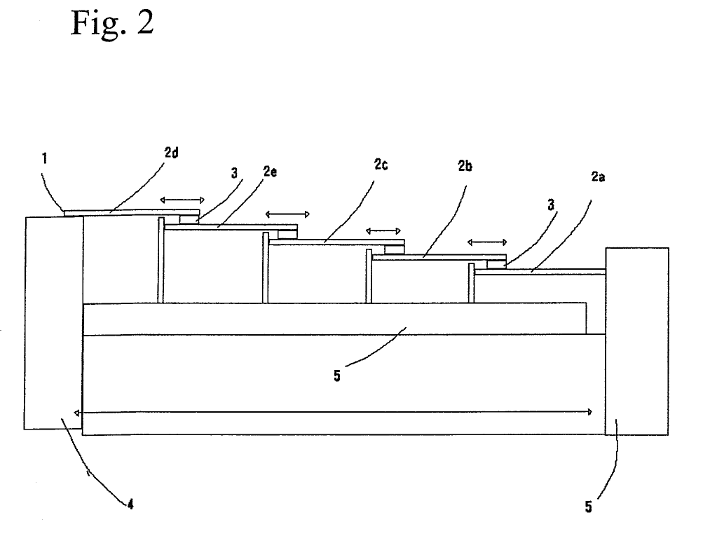

### DESCRIPTION OF THE PREFERRED EMBODIMENTS

The preferred embodiments will now be described with reference to the accompanying drawings, wherein like reference numerals designate corresponding or identical elements throughout the various drawings.

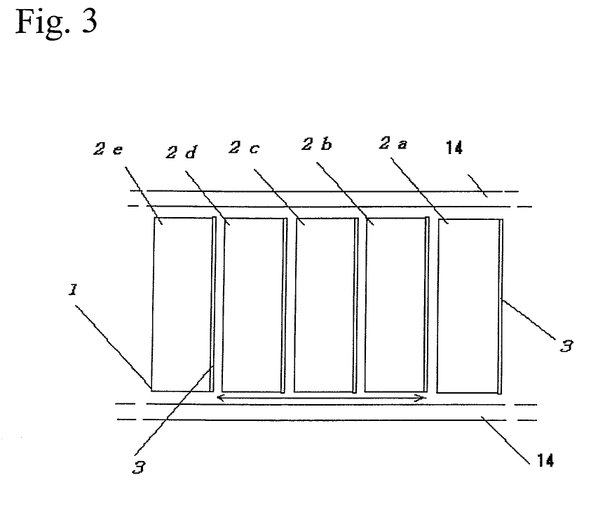

An explanation is made for example of high speed operation industrial machinery fitted with the ultra high speed movement telescopic cover (move by 60˜120 meter per one minute) of this invention. As shown in the FIG. 3, ultra high speed movement telescopic covers 1 is constructed by the partial covers 2a˜e, partial covers 2a˜e of ultra high speed movement telescopic cover 1 slide almost in a same level surface and in the directions of left to right.

It is free to change the stacking sequence of the each partial covers 2a˜e of the ultra high speed movement telescopic cover depending upon the discharging direction of chips and/or coolant as well as the moving direction of the high speed operation industrial machinery. For instance, partial cover 1a may be placed at the bottom and partial covers 2a˜e may be stacked

Each ultra high speed movement telescopic cover 1 consists of multiple pieces of partial covers 2a˜e made of metallic film of high strength multiple layers texture stainless sheet consists of mixture of ferritic phase, maltensitic phase and fine mixed texture with the main contents of 17% Cr˜2% Ni of 0.5˜3 mm thick and in a rectangular shape stacked so as to be able to slide in stacks, so that physical strength and friction resistance will be improved for the use of ultra high speed movement telescopic covers.

As for the shapes of the partial covers 2a˜e of the ultra high speed movement telescopic covers 1, any of square, round, oval, lid, roof, case shapes etc. may be used in addition to the rectangular shape. The numbers of the partial covers may be 3˜30 pieces and the width 5˜100 cm and the length 13˜50 cm are the adequate dimensions.

As for the above mentioned width and length of the partial covers 2a˜e may be different. For instance, partial cover 2a of the cover 1 may be 5 cm longer than the partial cover 2b, partial cover 1b may be 5 cm longer than the partial cover 2c, further the partial cover 2c may be 5 cm longer than the partial cover 2d, thus each cover length may be different.

The sliding portions at the edges of partial covers 2a˜d and 1a˜e are fitted with metallic film blades 3 so as to slide by pressing the sliding surfaces of the other partial covers.

As for the materials of the blade 3, the steel or stainless steel of carbon content 0.03˜0.1% and chromium content 10˜20% (hereafter called stainless steel of low carbon high chromium contents) is in use and this materials are the product of the recent development having the superior properties of high strength (tensile strength 1200˜2000N/mm 2) and sold with the product code of NISSIN Steel's SUS631, NSSHT1770, NSSHT1960 and NSSHT2000.

Low carbon high chromium stainless steel is rich with hardness (abrasion resistance) and special characteristics of low strength reduction against welding work. Therefore these materials use as the compact, lightweight and high accuracy blade 3 with the thickness 0.01˜0.3 mm.

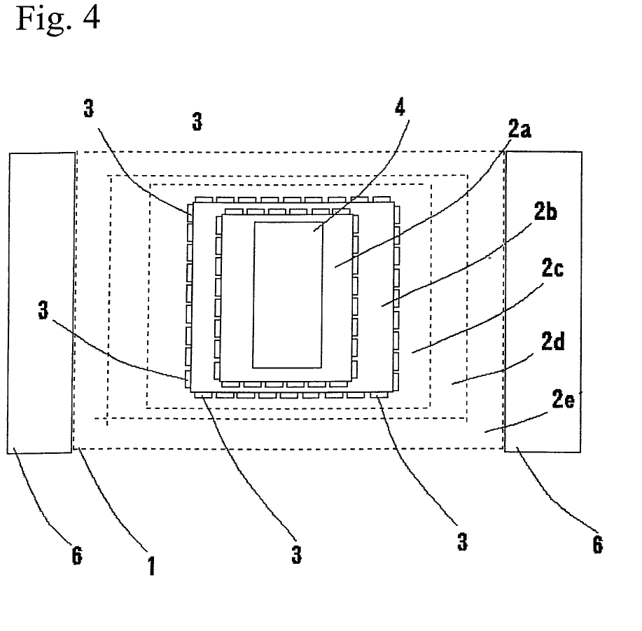

As shown in the FIG. 3, blades 3 made of low carbon high chromium stainless steel may be fixed onto the sliding portion of the partial covers 2a˜d with the width of 0.5˜3 cm, with the length of same as each partial covers, with the thickness of 0.01˜0.3 mm and of rectangular shape. Also, as shown in the FIG. 4, and also, multiple pieces of blades 3 of rectangular shape with 0.5˜3 cm width, 1˜5 cm length and 0.01˜0.3 mm thickness may be fixed onto the whole surface of the sliding portion of the each partial covers with the spacing of 1˜5 mm.

As for the fixing of the multiple pieces of blades 3, the numbers of blades to fit is, as the usual case, adequate with 2˜8 pcs/10 cm (at one partial cover) although it depends upon the size of the partial covers 2.

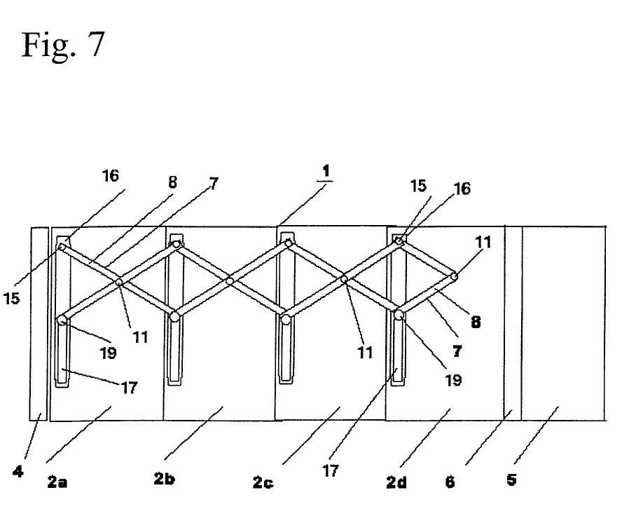

Also, by fitting the pantograph 7 into the ultra high speed movement telescopic cover 1, the linearity and sliding ability of the ultra high speed movement telescopic cover 1 may be improved. Fixing device of the pantograph 7 is, as shown in the FIG. 7, to mount the fitting pin 9 of various length and set so as to rotate in the slide plate 10 fixed at the lower side of the partial covers 2a˜d of the ultra high speed movement telescopic cover 1 and in the crossing points adjacent to the connecting pin 11 of the connecting bar 8 of the pantograph 7. In place of the slide plate 10, fitting base or other fixing device may be provided.

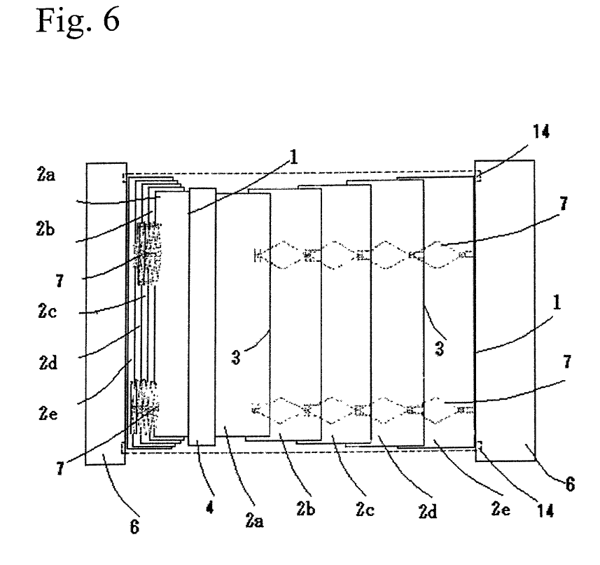

Also, as shown in the FIG. 6, between the 2 sets of the ultra high speed movement telescopic cover 1, the moving device 4 of the main spindle head etc. of the high speed operation industrial machinery is fixed so as to be able to slide.

the ultra high speed movement telescopic cover 1 fitted with metallic film blades 3 and the pantograph 7 is mounted onto holder 14 of u-shape section at the both edges so as to be able to slide the ultra high speed movement telescopic cover 1 fitted with metallic film blades 3 and the pantograph 7 is mounted onto holder 14 of u-shape section at the both edges so as to be able to slide

Explaining the working condition of the ultra high speed movement telescopic cover 1 of this invention using the FIG. 6, along with the movement of the moving device 4 moved towards the left direction after moved downwards, while the partial covers 2a˜e of the ultra high speed movement telescopic cover 1 slide with contraction downwards, the partial covers 2a˜e of the other ultra high speed movement telescopic cover 1 slide with extension downwards and thereafter, while the partial covers 2a˜e of the side ultra high speed movement telescopic cover 1 slide with contraction towards the right, the partial covers 2a˜e of the other side ultra high speed movement telescopic cover 1 slide with extension towards the left almost in the same plane level.

Also, along with the movement of the main spindle head 4 towards the left direction, while the partial covers 2a˜e of the ultra high speed movement telescopic cover 1 slide with contraction towards the left, the partial covers 2a˜e of the other ultra high speed movement telescopic cover 1 slide with extension towards the left. Also, if the moving device 4 slide towards the right direction, while the partial covers 2a˜e of the ultra high speed movement telescopic cover 1 slide with extension towards the right, the partial covers 2a˜e of the other ultra high speed movement telescopic cover 1 slide with contraction towards the right.

As mentioned in the above, along with the movement of the moving device 4, while the ultra high speed movement telescopic covers 1 slide with extension and contraction, the other ultra high speed movement telescopic covers 1 also slide with extension and contraction almost in the same plane level. In such event, the pantograph 7 also so slides with extension and contraction as to improve the sliding ability and linearity of the ultra high speed movement telescopic cover 1 and the ultra high speed movement telescopic cover 1, also at the same time, the blades 3 fixed onto the ultra high speed movement telescopic cover 1 and the ultra high speed movement telescopic cover 1 discharge out chips and/or coolant and the like and prevent penetration inside.

To have the carbon content of 0.03˜0.1% for the low carbon high chromium stainless steel to be used for blades 3 is to prevent the reduction of strength caused upon the welding of blades 3 direct to the partial covers 2, while the lower carbon content below 0.3% may improve the welding characteristics but also causes undesirable reduction of hardness of the blades 3 and higher carbon content of stainless steel beyond 0.1% cause reduction of strength when welding the blades 3 direct to the partial covers 2.

Also, to have the chromium content of 10˜20% for the low carbon high chromium stainless steel is to give higher hardness (abrasion resistance), while the lower chromium content below 10% may not give an adequate hardness to the blades 3 and higher chromium content beyond 20% may improve the hardness but also bring disadvantage in the elasticity.

Also, to have the thickness of 0.01˜0.3 mm for the low carbon high chromium stainless steel sheet to be used for metallic film blades 3 is to give high strength (tensile strength), elasticity etc. as well as to avoid excessive load to the moving device and the sliding portion of the ultra high speed movement telescopic cover by reducing the contact area and friction resistance of the sliding portion of the ultra high speed movement telescopic cover 1 with the resultant reduction of driving power required for the ultra high speed movement telescopic cover 1.

If the thickness of the low carbon high chromium stainless steel sheet is below 0.01 mm, adequate hardness and physical strength required for the blades 3 may not be obtained also to manufacture the thinner blades 3 below 0.01 mm thickness calls for higher cost and inconvenience of production, also if the thickness of low carbon high chromium stainless steel sheet is thicker beyond 0.3 mm it calls for inconvenient disadvantages in elasticity and weight of the blades 3.

The edge of the metallic film blade 3 is welded onto the sliding portion at the edge of the partial covers 2 and protrusion from the partial cover (0.05˜1 mm) is used as the blade.

The shape of the blade 3 may be any shape provided it is a flat plate and the top of the blade 3 is protruded from the partial cover 2. Also, as for the welding method to fit the one end of the blade 3 onto the partial cover 2, spot welding or laser welding is desirable but other welding method may also be possible.

To fit the blade 3 onto partial cover 2, other fitting method than welding as mentioned as above, for instance, fitting by glue may be possible at the sliding face of the partial cover 2 and the edge of the blade 3, also fitting by glue and riveting may be possible so as to prevent the penetration of coolant and fitting is easier too.

Regarding the fixing of the metallic film blade 3 to the sliding portions of the partial cover 2, of blade 3, if the blade is bent to form in the shape of < or [symbol] , it improves the accuracy so that the blade 3 becomes stronger and more stable to hold pressure and improves sealing and sweeping abilities remarkably against liquid and/or impurities.

As for the materials of pantograph 7, stainless steel may be used, however to improve the physical strength of the pantograph 7, the use of the high strength stainless multiple layer steel of mixed texture consists of the soft ferritic phase, hard maltensitic phase and the fine grain texture with the main content of 17% Cr and 2% Ni may be used.

As for the materials of fitting pin 9 of the pantograph 7, stainless steel may be used, however, the use of the stainless steel with grain boundary nitriding treatment will have the following features: The surface of the fitting pin 9 will be hardened to have superior sliding ability and high physical strength which can bear for the excessive load charged to the fitting pin 9 of the connecting bar 8 of the pantograph 7 and will not become loose by surface damage, while the inside of the pin 9 holds elasticity as not hardened to the center, and the pin 9 will not be bend or broken therefore flexibility and sliding ability of the pantograph 7 are improved keeping the stable and smooth operation in the long run.

Also, as for the connecting bar 8 of the pantograph 7, the use of laminations of 2˜10 pieces stainless spring steel sheets of 0.13 mm thick will increase the characteristics of the connection bar 8 in its elasticity, stiffness, physical strength and also will improve flexibility thus providing pantograph 7 with more elasticity.

Namely, when used for the pantograph 7 of the ultra high speed movement telescopic cover 1, the connecting bar 8 made of the laminated stainless spring steel sheet supple each other with flexibility to stand for the overload and does not bend nor break and thus increases elasticity, sliding ability, linearity of the pantograph 7 remarkably also improves stable and smooth operation in the long term.

As for the fitting of the pantograph 7 to the ultra high speed movement telescopic cover 1, as shown in the FIG. 7, fix the fitting pin 9 of the pantograph 7 to the partial covers 2a˜d of the ultra high speed movement telescopic cover 1 and also insert the sliding fitting pin 11 of the pantograph 7 into the slit guide 17 of the slit plate 16 fixed on to the partial covers 2a˜d of the ultra high speed movement telescopic cover 1 so as to be able to slide.

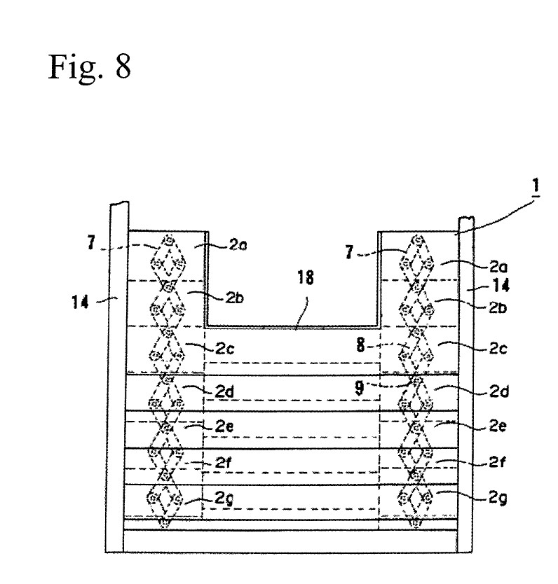

As shown in the FIG. 8, fitting pins 8 are fixed onto the partial covers 2a˜2d of the telescopic over 1 and slide fitting pins 9 of the pantograph 7 are also fixed so as to be able to slide into the slit 11 of the shock absorbing material 10 in ring shape as shown in FIG. 8 so that shocks may be absorbed upon pantograph is shrunken.

As for fitting of the pantograph 7 to the same width but of the different length rectangular shape of the partial covers 2a˜d of the ultra high speed movement telescopic cover, when the partial covers 2a˜d are contracted entirely, spaces are obtained as longer as the differences of each cover length and these spaces may be used for fittings of the slide plate 10 to insert the fitting pin 9.

However, as for fitting of the pantograph 7 to the partial cover 1a˜d of the same width and the length of the ultra high speed movement telescopic cover 1, when the partial covers 2a˜d are contracted entirely, there are no space because no different length. Therefore as shown in the FIG. 8, by provision(s) of the recess 18 in different length at the end of the partial covers 2a˜d, fix the pantograph 7 to the slits of these recesses, thus the ultra high speed movement telescopic cover 1 may be made compact in size.

Also, the pantograph 7 to be fitted to the ultra high speed movement telescopic cover 1, if provided in parallels of 2 lines or more at the spacing of 10˜50 cm, will have improvements of the sliding ability and linearity of those ultra high speed movement telescopic covers.

Especially, if the connecting bar 8 is made of multiple layer construction of the high strength lamellae structure stainless sheet, the connecting bars 8 supple each other with flexibility to stands for the overload to the pantograph 7, and the sliding ability and linearity of the pantograph 7 are increased so that the stable and smooth operation will be kept in the long run.

Also, once lubricant is injected between the sides of the laminated connecting bars 8, the lubricant penetrates inside by capillary phenomenon to the whole side faces of the each connecting bars8, not only the lubricant is kept at the each side of the connecting bars 8 in impregnated condition but also to give the lubricant constantly to around the each connecting bars 8 and the fitting pins 9 by the lubricant seeped out of the sides of the each connecting bars 8 thus the sliding ability and linearity of the pantograph 7 are improved remarkably, stable and smooth operation of the pantograph 7 is achieved and no wears are observed around the connecting bars 8 and the fitting pins 9 as well as no noise and trouble will occur.

Also, when the pantograph 7 is fitted to the partial covers 2a˜d of the ultra high speed movement telescopic cover 1, upon sliding, load is charged mainly onto the partial covers 2a and 2d which are fitted with the moving device 4 of the main spindle head etc. of the high speed operation industrial machinery 5 and fitted with the fixing device 6 of the high speed operation industrial machinery 5, the partial cover 2a and the partial cover 2d are likely to be bent, in such the case, fit the stiffener plate(s) (not shown in the drawing) to both or either of the moving device 4 of the spindle head etc. of the high speed operation industrial machinery 5 and the fixing device 6 of the high speed operation industrial machinery 5 then the pantograph 7 may be fitted to the said stiffener plate(s).

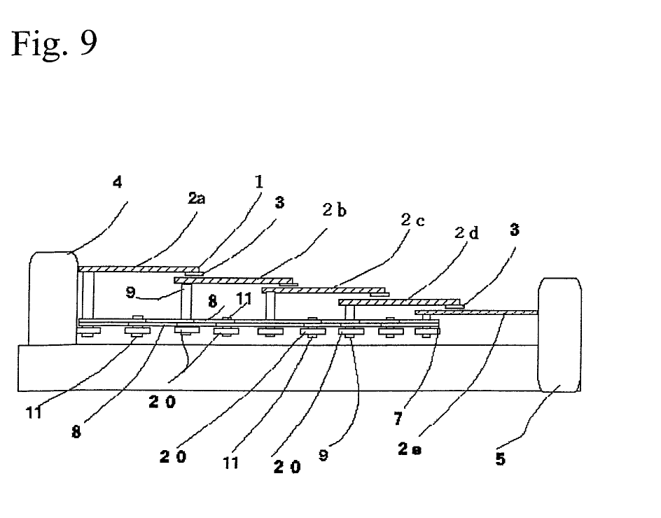

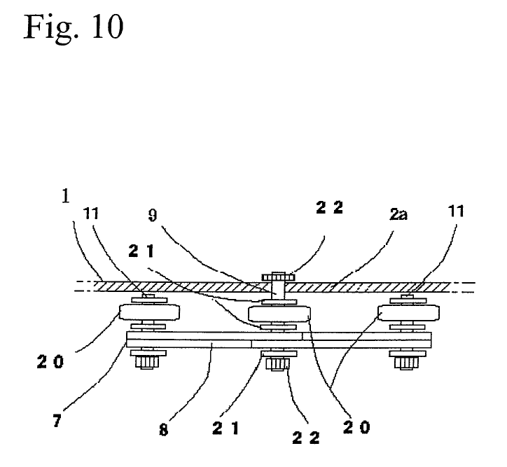

As shown in the FIG. 9 and FIG. 10, slide pins 19 are provided to the crossing points of connecting bars 8 of the pantograph 7 so as to be able to rotate and pantograph 7 is fixed to the partial covers 2a˜2d of the ultra high speed movement telescopic cover 1 through by the fitting pins 9 fixed into the contact point of the connecting bars 8 so as to be able to rotate. To these sliding pins 19 and the fitting pins 9 of the pantograph7, shock absorbing material in ring shape 20 of the outerdiameter slightly larger than the width of the connection bar 8 and made of urethane are fitted to the slide pins 19 and fitting pins 9 of the pantograph 7 through the ring washer21 and set by screws 22 so that the collision of the connecting bars 8 of the pantograph 7 are prevented and shock is absorbed s well as breakage of pantograph 7 and damage to the ultra high speed movement telescopic cover 1, generation of abnormal sound and noise are prevented. As for the material of the shock absorbing material in ring shape 20, in addition to the said urethane, rubber, nitrite ? rubber, felt and any other material may be used if it is considered suitable to have shock absorbing ability, and the outer diameter of the shock absorbing material in ring shape 20 may have to be adequately decided by the width of the connecting bar 8 of the pantograph 7 and, for usual case, the diameter may be about 1˜5 mm larger than the width of the connecting bar 8 and thickness of the shock absorbing material may be about 0.5˜3 mm.

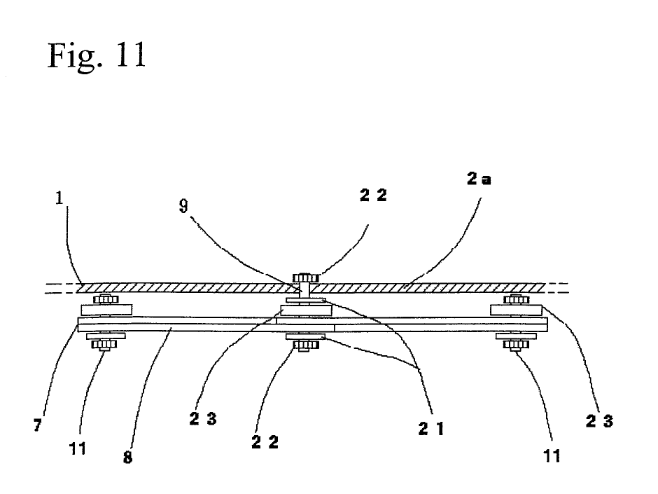

Also as shown in the FIG. 11, instead of using shock absorbing material in ring shape 20 made of urethane inserted into slide pins 19 and fitting pins 9, slide control material in ring shape 23 made of magnet with the outer diameter

Almost same size as with the width of the connecting bar 8 of the pantograph 7, inserted through its hole to the slide pins 19 and fitting pins 9 and fixed by screw so that slide movement is controlled by the magnet force of the slide control material in ring shape 23 made of magnet upon pantograph 7 is shrunken, in other word, the collision of the connecting bars 8 may be prevented by slight increase of slide friction of the connecting bars 8 with the magnet force. As for the materials of the slide control material 23, above mentioned magnet such as ferrite and rare earth metal etc. may be suitable and the outer diameter of the slide control material in ring shape 23 may be same as the width of the connecting bar 8 of the pantograph 7 or slightly smaller and the thickness of the slide control material in ring shape 23 may be about 0.5˜3.0 mm

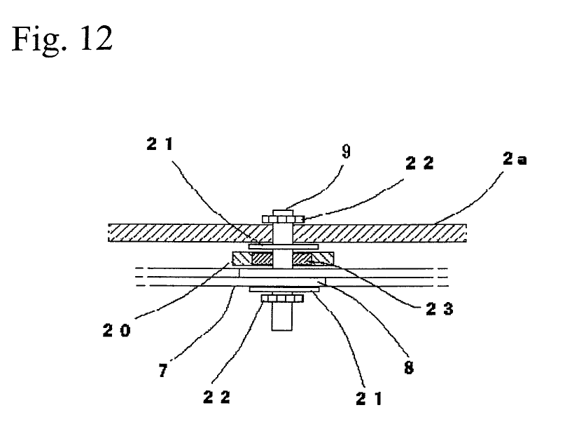

Also as for the fitting of the shock absorbing material in ring shape 20 to the slide pins 19 and fitting pins 9 of the pantograph 7, as shown in the FIG. 12, slide control material in ring shape 23 made of magnet may be inserted into shock absorbing material in ring shape 20 made of yrethane of the outside diameter slightly larger than the width of connecting bar 8 of the pantograph 7 so that the shock of collision between connecting bars 8 will be absorbed and/or such collision will be prevented upon connecting bars 8 are shrunken.

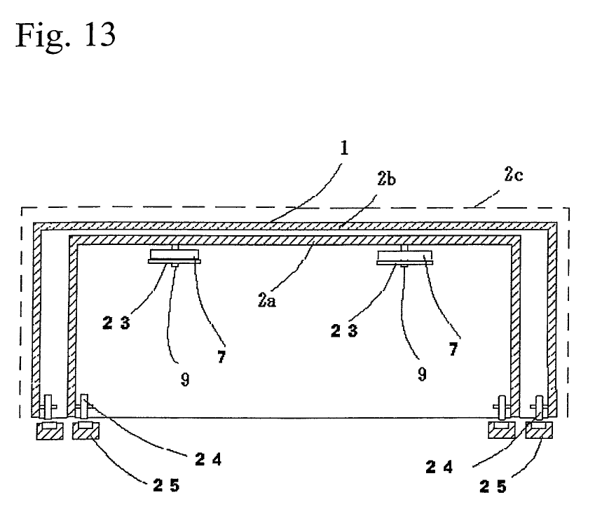

Also if the sliding ability of the ultra high speed movement telescopic cover 1 is not smooth, as shown in FIG. 13, roller 24 and roller guide 25 may be fitted to at least four corners or more so that the sliding ability is improved.

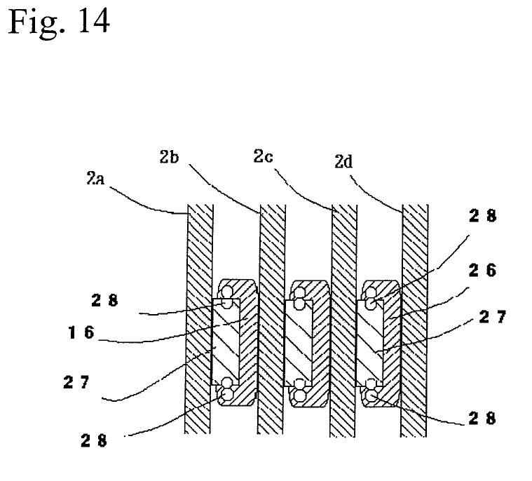

Also as shown in the FIG. 14, slide control guide 26 is fitted to a certain point of the partial cover 2 of the ultra high speed movement telescopic cover 1 by inserting into the slide rail 27 so that the sliding ability of the ultra high speed movement telescopic cover1 is improved and as for the slide control guide 26, it is recommendable to use NB Slideguide of Nippon Bearing Co. Ltd., which slide guide are made of ball bearing 28 mounted in ring shape (bearing balls mounted in a ring shape) for instance of the product No. SEB, SEB-A and SEB-AY are considered to be suitable. Other than the said roller 24 and slide control guide 26, wheels, bearings and other type of movement smoothing device may be used.

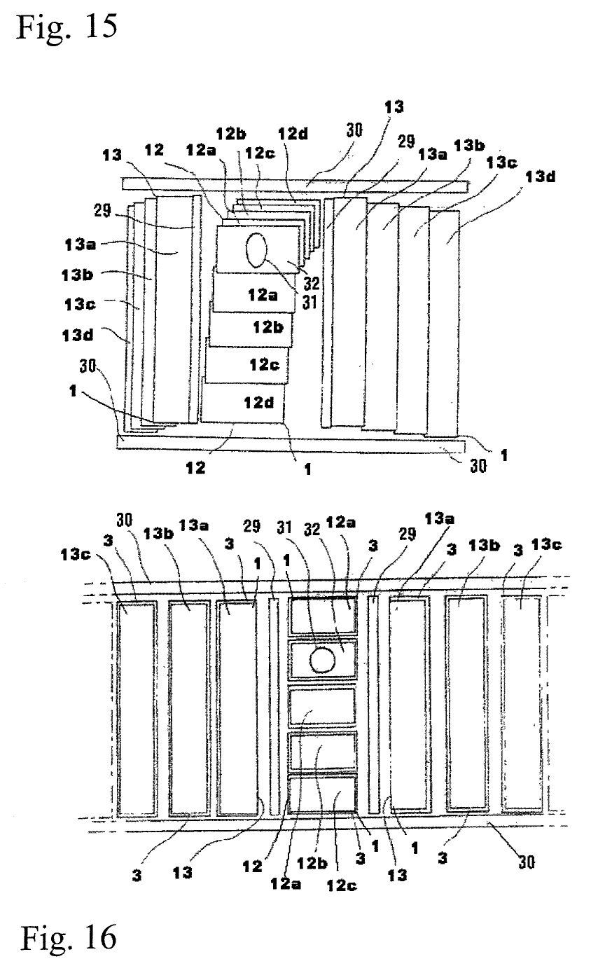

An explanation is made for example of high-speed operation industrial machinery fitted with the crossways sliding ultra high-speed movement telescopic cover of this invention. As shown in the FIG. 15, the cross ways sliding cover 1 is constructed by 2 sets of the center ultra high speed movement telescopic covers 12 and 2 sets of the side ultra high speed movement telescopic covers 13. For instance, in case the partial covers 12a˜d of the center ultra high speed movement telescopic cover 12 slide in the direction of up and down, 2 sets of the partial covers 13a˜d of ultra high speed movement telescopic cover 13 are fitted onto the both sides of the partial covers 12a˜d of the center ultra high speed movement telescopic cover 12 but in the right angle direction against the sliding direction of partial covers 12a˜d so as to make the 2 sets of the partial covers 13a˜d of the side ultra high speed movement telescopic cover 13 slide almost in a same level surface and in the directions of left to right.

Each center ultra high speed movement telescopic cover 12 consists of multiple pieces of partial covers 12a˜e made of stainless steel sheet etc. of 0.5˜3 mm thick and in a rectangular shape stacked so as to be able to slide in stacks and the each side ultra high speed movement telescopic covers 13 also consists of multiple pieces of partial covers 13a˜d made of stainless steel sheet etc. of 0.5˜3 mm thick and in a rectangular shape stacked so as to be able to slide.

It is free to change the stacking sequence of the each partial covers 12a˜e as well as 13a˜e of the ultra high speed movement telescopic cover depending upon the discharging direction of chips and/or coolant as well as the moving direction of the high speed operation industrial machinery. For instance, partial cover 12a may be placed at the bottom and 12b˜d may be stacked over the 12a (same with the partial covers 13a˜d)

As shown in the FIG. 16, the sliding portions at the edges of partial covers 12 and 13 are fitted with metallic film blades 3 so as to slide by pressing the sliding surfaces of the other partial covers.

To fix the metallic film blades, as shown in the FIG. 3, fix the metallic film blade 3 onto the sliding portion of the partial cover 12a˜d and 13a˜d or fix the multiple pieces of the rectangular metallic film blades 3 with the spacing of 1-5 mm onto the surfaces of sliding portions at the edges of the partial covers 12a˜d and 13a˜d as shown in the FIG. 4. Also as shown in the FIG. 6, multiple pieces of the rectangular metallic film blades 3 may be fixed onto the whole surfaces of sliding portions at the edges of the partial covers 12a˜d and 13a˜d with the spacing of 1-5 mm.

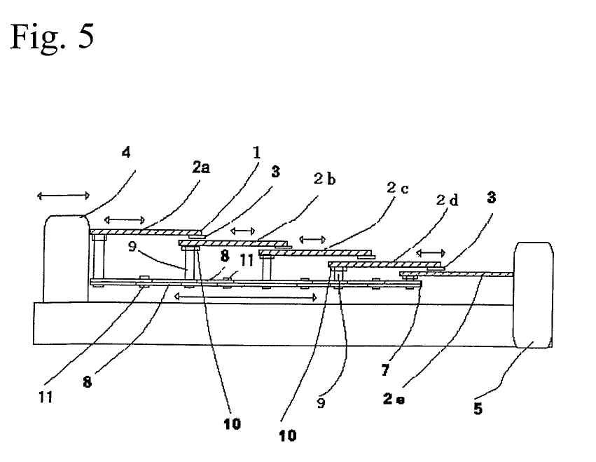

Also, by fitting the pantograph 7 into the center ultra high speed movement telescopic cover 12 and side ultra high speed movement telescopic cover 13, the linearity and sliding ability of the ultra high speed movement telescopic cover 1 may be improved. Fixing device of the pantograph 7 is, similarly to the case as shown in the FIG. 5, to mount the fitting pin 9 of various length and set so as to rotate in the slide plate 10 fixed at the lower side of the partial covers 12a˜d of the center ultra high speed movement telescopic cover 12 and in the crossing points adjacent to the connecting pin 11 of the connecting bar 8 of the pantograph 7. In place of the slide plate 10, fitting base or other fixing device may be provided (same as the side ultra high speed movement telescopic cover 13)

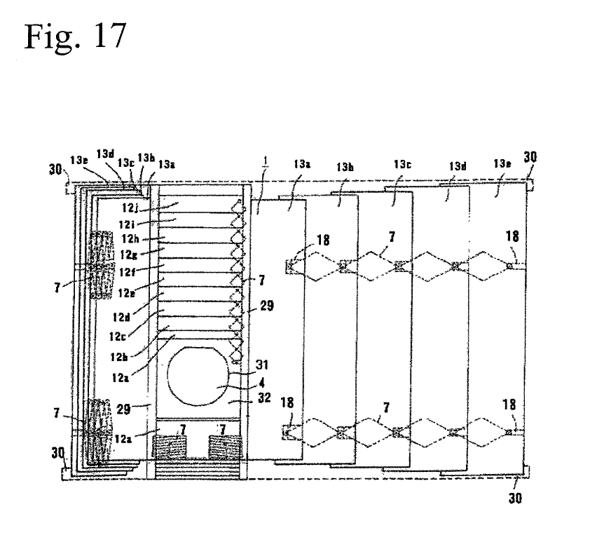

Also, as shown in the FIG. 17, between 2 sets of the center ultra high speed movement telescopic cover 12, the moving device cover 32, provided with the mounting holes 31 to fix the moving device 4 of the main spindle head etc. of the high speed operation industrial machinery, is mounted so as to be able to slide in stacks. In this case, position the moving device cover 32 at the top, then place partial covers 12a˜j of the center ultra high speed movement telescopic cover 12 beneath the moving device cover 32 so as to be able to slide whole system so that solid pieces such as chips and/or liquid such as coolant may be discharged out easily and prevention may become easier against the penetration to the inside of the moving device of the high speed operation industrial machinery.

Also, as shown in the FIG. 17, between 2 sets of the center ultra high speed movement telescopic cover 12, the center cover 13 with the mounting hole 31 to fix the moving device 4 of the main spindle head etc. of the high speed operation industrial machinery, is fixed so as to be able to slide. In this case, position the moving device cover 32 at the top then place partial covers 12a˜j of the center ultra high speed movement telescopic cover 12 beneath the moving device cover 32 so as to be able to slide whole system so that solid pieces such as chips and/or liquid such as coolant may be discharged out easily and prevention may become easier against the penetration to the inside of the moving device of the high speed operation industrial machinery.

Also, as mentioned in the above, the center ultra high speed movement telescopic cover 12 and the side ultra high speed movement telescopic cover 13 are constructed so as to slide each other in the crossways directions. Upon setting of 2 sets of the side ultra high speed movement telescopic cover 13 at the both sides of the center ultra high speed movement telescopic cover 12, place 2 sets of the center ultra high speed movement telescopic cover 12 at the top then place 2 sets of the side ultra high speed movement telescopic cover 13 so as to slide whole system so that solid piece such as chips and/or liquid such as coolant may be discharged out easily and the prevention may become easier against the penetration inside the moving device of the high speed operation industrial machinery.

Also, according to the usage of the ultra high speed movement telescopic cover 1, the center ultra high speed movement telescopic cover 12 may be placed at the bottom and place 2 sets of the side ultra high speed movement telescopic covers upper, contrary to the above case, so as to be able to slide whole system.

As shown in the FIG. 17, the center ultra high speed movement telescopic cover 12 fitted with metallic film blades 3 and the pantograph 7 is mounted onto center holder 29 of u-shape section at the both edges so as to be able to slide and the side ultra high speed movement telescopic cover 13 fitted with metallic film blades 3 and pantograph 7 is mounted onto the side holder 30 of u-shape section at the both edges so as to be able to slide.

Explaining the working condition of the ultra high speed movement telescopic cover 1 of this invention which ultra high speed movement telescopic cover slides in the cross ways directions using the FIG. 17, the high speed operation industrial machinery 5 adjacent to the cutting machine (not shown in the drawing) is covered by the center ultra high speed movement telescopic cover 12(mentioned below) and the side ultra high speed movement telescopic cover 13, as well as the moving device 4 of the spindle head etc. of the high speed operation industrial machinery 5 is fixed into the fitting holes 11 of the center cover 14 of the center ultra high speed movement telescopic cover 12.

Along with the movement of the main spindle head etc. of the high speed operation industrial machinery 5 in operation, the partial covers 12a˜j of 2 sets of center ultra high speed movement telescopic cover 12 and the partial covers 13a˜j of the side ultra high speed movement telescopic cover 13 slide almost in the same plane level. For instance, if the moving device 4 of the high speed operation industrial machinery 5 slides downwards, while the partial covers 12a˜j of the center ultra high speed movement telescopic cover 12 slide with contraction downwards, the partial covers 12a˜j of the other center ultra high speed movement telescopic cover 12 slide upwards with extension downwards. Also, if the moving device 4 slide upwards, while the partial covers 12a˜j of the center ultra high speed movement telescopic cover 12 slide upwards with extension upwards, the partial covers 12a˜j of the other center ultra high speed movement telescopic cover 12 slide with contraction upwards. (The partial covers 13a˜j of the side ultra high speed movement telescopic cover 13 are standing still.)

Also, along with the movement of the main spindle head 4 towards the left direction, while the partial covers 13a˜j of the side ultra high speed movement telescopic cover 13 slide with contraction towards the left, the partial covers 13a˜j of the other side ultra high speed movement telescopic cover 13 slide with extension towards the left. Also, if the moving device 4 slide towards the right direction, while the partial covers 13a˜j of the side ultra high speed movement telescopic cover 13 slide with extension towards the right, the partial covers 13a˜j of the other center ultra high speed movement telescopic cover 13 slide with contraction towards the right. (The partial covers 13a˜j of the center ultra high-speed movement telescopic cover 12 are standing still.

Also, along with the movement of the moving device 4 moved towards the left direction after moved downwards, while the partial covers 12a˜j of the center ultra high speed movement telescopic cover 12 slide with contraction downwards, the partial covers 12a˜j of the other center ultra high speed movement telescopic cover 12 slide with extension downwards and thereafter, while the partial covers 13a˜j of the side ultra high speed movement telescopic cover 13 slide with contraction towards the right, the partial covers 13a˜j of the other side ultra high speed movement telescopic cover 13 slide with extension towards the left almost in the same plane level.

Also, along with the movement of the moving device 4 moved towards the right direction after the movement upwards, while the partial covers 12a˜j of the center ultra high speed movement telescopic cover 12 slide with extension upwards, the partial covers 12a˜j of the other center ultra high speed movement telescopic cover 12 slide with contraction upwards and thereafter, almost in the same plane level, while the partial covers 13a˜j of the side ultra high speed movement telescopic cover 13 slide with extension towards the right, the partial covers 13a˜j of the other side ultra high speed movement telescopic cover 13 slide with contraction towards the right.

As mentioned in the above, along with the movement of the moving device 4, while the center ultra high speed movement telescopic covers 12 slide with extension and contraction, the other side ultra high speed movement telescopic covers 13 also slide with extension and contraction almost in the same plane level. In such event, the pantograph 7 also so slides with extension and contraction as to improve the sliding ability and linearity of the center ultra high speed movement telescopic cover 12 and the side ultra high speed movement telescopic cover 13, also at the same time, the blades 3 fixed onto the center ultra high speed movement telescopic cover 12 and the side ultra high speed movement telescopic cover 13 discharge out chips and/or coolant and the like and prevent penetration inside.

As for the materials, other than stainless steel as mentioned in the above, of the center ultra high speed movement telescopic cover 12 and the side ultra high speed movement telescopic cover 13, metallic film of high strength multiple layers texture stainless sheet consists of mixture of ferritic phase, maltensitic phase and fine mixed texture with the main contents of 17% Cr˜2% Ni may be used so that physical strength and friction resistance will be improved for the use of ultra high speed movement telescopic covers.

As for the shapes of the partial covers 12a˜d of the center ultra high speed movement telescopic covers 12 and the partial covers 13a˜d of the side ultra high speed movement telescopic covers 13, any of square, round, oval, lid, roof, case shapes etc. may be used in addition to the rectangular shape. The numbers of the partial covers may be 3˜30 pieces and the width 5˜100 cm and the length 13˜50 cm are the adequate dimensions.

Also, the pantograph 7 to be fitted to the center ultra high speed movement telescopic cover 12 and the side ultra high speed movement telescopic cover 13, if provided in parallels of 2 lines or more at the spacing of 10˜50 cm, will have improvements of the sliding ability and linearity of those ultra high speed movement telescopic covers.

Also, to the slide pins 19 and the fitting pins 9 of the pantograph 7 to be fitted to the center ultra high speed movement telescopic cover 12 and to the side ultra high speed movement telescopic cover 13,shock absorbing material in ring shape 20 of the outerdiameter slightly larger than the width of the connecting bars8 of the pantograph 7 are inserted, or slide control material in ring shape 23 made of magnet and of outer diameter almost same as the width of the connecting bars 8 are inserted, or slide control material made of magnet 23 is inserted into the shock absorbing material in ring shape 20 made of urethane and of the outer diameter

Of slightly larger than the width of the connecting bar 8, so that the collisions between connecting bars 8 are prevented and shocks are absorbed as well as to prevent the breakage of the pantograph 7, damage to the ultra high speed movement telescopic cover 1 and generations of abnormal sound and noise.

Also if the sliding ability of the center ultra high speed movement telescopic cover 12 and the side ultra high speed movement telescopic cover 13 is not smooth, rollers 24 and roller guides 25 may be fitted at least four corners or more beneath the ultra high speed movement telescopic cover 1, so that the sliding ability of the ultra high speed movement telescopic cover is improved.

According to the invention, it is possible to slide reciprocally the ultra high speed movement telescopic cover fitted with the metallic fin blades almost in the same plane level smoothly along with the movement of the moving device of the spindle head etc. of the high speed operation industrial machinery, consequently it is possible to discharge chips and/or coolant, to prevent penetration inside of chips and/or coolant through the gaps of ultra high speed movement telescopic cover and also to have the superior merits of keeping smooth operation of the moving device of the high speed operation industrial machinery and give full performance to the high speed operation industrial machinery.

Especially, using the materials of high strength multiple layer texture stainless steel for the ultra high speed movement telescopic cover, in comparison with the other materials, the thickness of the partial covers of the ultra high speed movement telescopic cover may be reduced consequently the size of the ultra high speed movement telescopic cover may be as smaller as ½˜⅕ as well as the weight as lighter as ½˜⅕, also the elasticity, the sliding ability, the frictional resistance, the endurance and the physical strength may become as stronger as 2˜5 times in comparison of using other materials

Also, according to the invention, by fixing the metallic film blades onto the part or whole faces of the ultra high speed movement telescopic cover, the penetration of chips and/or coolant etc. through the gaps of the ultra high speed movement telescopic cover is prevented securely and consequently the smoother movement of the moving device may be held and full performance of the high speed operation industrial machinery will be shown.

Especially, the use of the metallic film blades made of low carbon high chromium stainless steel provides the lighter weight and smaller contact area of the partial covers (⅛˜1/18), consequently improvements (3˜10 times) are given to the reduction of frictional resistance, to the endurance, to the sliding ability and to the sealing ability as well as the reduction of the blade thickness to ⅛˜1/25 compared with the conventional rubber blade, the reduction of the whole size of the ultra high speed movement telescopic cover to as compact as ⅛˜⅕ and the reduction of the weight as lighter as ⅛˜1/7.

Also, according to the invention, by the adoption of the pantograph onto the ultra high speed movement telescopic cover, the partial covers of the ultra high speed movement telescopic cover are slid simultaneously in the same distance, evenly and without noise consequently the merits of improved sliding ability and linearity are given.

Especially, using the materials of high strength multiple layer texture stainless steel for the pantograph, in comparison with the use of the other materials, the merits are given to the reductions of thickness, of sizes in compact and of weigh of the pantograph.

Also according to the invention, by the use of the shock absorbing material in ring shape inserted into the pantograph, there are a several merits that abnormal sound and noise upon the reciprocal movement of the ultra high speed movement telescopic cover are prevented and, the even uniform and linear movement of the ultra high speed movement telescopic cover are achieved and breakage of the pantograph and/or damage of the ultra high speed movement telescopic cover are prevented.

Also, according to the invention, by the provisions of movement smoothing device such as rollers, slide control guides etc. to the ultra high speed movement telescopic cover, it is become available to reduce the friction resistances, to improve durability and anti-abrasion characteristics as well as to maintain uniform and linear sliding ability of the ultra high speed movement telescopic cover and to have the stable reciprocal movement of the ultra high speed movement telescopic cover.

Obviously, numerous modifications and variations of the present invention are possible in light of the above teachings. It is therefore to be understood that within the scope of the appended claims, the invention may be practiced otherwise than as specifically described herein.

The present application relates to Japanese Patent Application Nos. 10-150757, 10-150758 and 11-341738, filed May 15, 1998, May 15, 1998 and Dec. 1, 1999, respectively. The contents of these applications are incorporated herein by reference in their entirety.

What is claimed as new and desired to be secured by Letters Patent of the United States is:

1. The ultra high speed movement telescopic cover fixed, at its end, on the moving device of the main spindle head and the like of industrial machinery, caused to move slidably back or forth, and right or left according as the movement of the moving device thereof and thereby move slidably a plurality of blades for discharging chips and/or coolant and the like, which telescopic cover comprising a number of metallic film partial covers slidably placed in layers, such partial covers being made of metallic film of high tensile strength multiple layer texture stainless steel films which consists mainly of 17% Cr˜2% Ni content provided with mild ferritic phase, hard maltensitic phase and fine mixed texture, the metallic film blade made of steel or stainless steel containing 0.03˜0.1% carbon and 10˜20% chromium, 0.01˜0.3 mm in thickness, being fixed on the sliding surface, in part or whole, on each partial cover attached to the metallic film of said telescopic cover and one or more pantographs attached to each partial cover of said metallic film.

2. The ultra high speed telescopic cover of the above claim 1, in which metallic film blades made of steel or stainless steel containing 0.03˜0.1% carbon and 10˜20% chromium, 0.01˜0.3 mm in thickness, being fixed at intervals of 1˜5 mm on the sliding surface, in part or whole, on each partial cover attached to the metallic film of said telescopic cover.

3. The ultra high speed movement telescopic cover of the above claim 1, which pantograph is formed of the metallic film of 17% Cr˜2% Ni high strength stainless steel of which comprises multiple layer fine mixed texture of mild ferritic phase and maltensitic phase.

4. The ultra high speed movement telescopic cover of the above claim 1, having the sliding pins and the fitting pins of the pantograph fitting to the ultra high speed movement telescopic cover and such pins are fitted with the shock absorbing material in ring shape of the outer diameter slightly larger than the width of the connecting bars of the ultra high speed movement telescopic cover, or slide control material in ring shape of the outer diameter almost same size as the width of the connecting bars of the pantograph, or shock absorbing material in ring shape of outer diameter slightly larger than the width of the connecting bar of the pantograph inserted with the slide control material inside and absorbing the shocks of collision between connecting bars upon pantograph is shrunken.

5. The ultra high speed movement telescopic cover of the above claim 1, having smoothing device such as slide control guide and slide rail etc. to at least four corners or more of the partial cover of the ultra high speed movement telescopic cover so that sliding ability of the ultra high speed movement telescopic cover is improved.

6. The ultra high speed movement telescopic cover which slide in the cross ways directions, comprise the center ultra high speed movement telescopic covers and the side ultra high speed movement telescopic covers, each partial covers of the center ultra high speed movement telescopic cover and the side ultra high speed movement telescopic cover are formed of metallic film of high tensile strength multiple layer texture stainless steel which comprises 17% Cr˜2% Ni content but with mixed quality of mild ferritic phase, hard maltensitic phase and fine mixed texture and are stacked so as to be able to slide each other, and each partial covers of both of the ultra high speed movement telescopic covers are fitted with metallic film blades of 0.01˜0.3 mm in thickness and made of carbon content 0.03˜0.1%, Chromium content 10˜20% steel or stainless steel onto one or whole sliding portions of the both ultra high speed movement telescopic cover and fitted with one or multiple pieces of pantograph onto the ultra high speed movement telescopic cover, the end of the center ultra high speed movement telescopic cover thus constructed is stacked onto both sides of the center partial cover provided with fitting holes to mount the moving device of the spindle head etc. of the high speed operation industrial machinery so as to be able to slide, and at one side or both sides of the center ultra high speed movement telescopic cover, side ultra high speed movement telescopic cover is fixed with the multiple pieces of the above mentioned partial covers stacked so as to be able to slide providing the sliding direction of the partial covers of the side ultra high speed movement telescopic covers in the right angle direction but almost in the same plane level of the partial covers of the center ultra high speed movement telescopic cover, having both of the center ultra high speed movement telescopic cover and the side ultra high speed movement telescopic covers slid in the cross ways directions either back and forth, left and right, and/or right to left and up and down almost in the same plane level along with the movement of moving device of high speed operation industrial machinery, to seal to discharge chips and/or coolant by the sliding movement of the multiple blade pieces, and to improve characteristics of sliding ability etc.

7. The ultra high speed movement telescopic covers which slide in the cross ways directions comprise the center ultra high speed movement telescopic covers and the side ultra high speed movement telescopic covers as described in the above claim 6 and the both ultra high speed movement telescopic covers are fitted with metallic film blade made of 0.01˜0.3 mm thickness and of carbon content 0.03˜0.1%, Chromium content 10˜20% steel or stainless steel with the spacing of 1˜5 mm onto one or whole sliding portions of the both ultra high speed movement telescopic covers.

8. The ultra high speed movement telescopic covers which slide in the cross ways directions comprise the center ultra high speed movement telescopic covers and the side ultra high speed movement telescopic covers as described in the above claim 6 or claim 7, and fitted with the pantographs formed of the metallic film of 17% Cr˜2% Ni high strength stainless steel of which comprises multiple layer fine mixed texture of mild ferritic phase and maltensitic phase,

9. The ultra high speed movement telescopic covers which slide in the cross ways directions comprise the center ultra high speed movement telescopic covers and the side ultra high speed movement telescopic covers as described in the above claim 6, and such provisions are made to the sliding pins and the fitting pins to fix the pantograph onto the center ultra high speed movement telescopic covers and side ultra high speed movement telescopic covers that shock absorbing material in ring shape of the outer diameter slightly larger than the width of the connecting bar of the pantograph, or slide control material in ring shape of the outer diameter almost same size as the width of the connecting bars of the pantograph, or shock absorbing material in ring shape of the outer diameter slightly larger than the width of the connecting bars of the pantograph inserted with the slide control material so that the shocks by the collision are absorbed upon the pantographs are shrunken.

10. The ultra high speed movement telescopic cover fitted with pantographs as described in the above claim 1, which are fitted with smoothing device such as rollers and rails and/or slide control guide and slide rails onto at least four corners or more of the partial covers of the ultra high speed movement telescopic covers so that sliding ability of the ultra high speed movement telescopic covers are improved.
